(19) United States
(12) Patent Application Publication
(10) Pub. No.: US 2012/0267006 A1
(43) Pub. Date: Oct. 25, 2012

(54) FUNNEL STRUCTURE FOR OIL CASE

(76) Inventor: Po-Lin LIAO, Taichung (TW)

(21) Appl. No.: 13/211,772

(22) Filed: Aug. 17, 2011

(30) Foreign Application Priority Data
Apr. 20, 2011 (TW) 100206886

(51) Int. Cl. B67C 11/02

(52) U.S. Cl. 141/331

(57) ABSTRACT

A funnel structure includes a funnel body, which has a top surface made inclining at a predetermined slope and a circumferential wall forming opposite cut-offs for stably holding an oil bottle that pours oil into an oil case and has a bottom end forming a joint tube and a first key, an extender, which has a top end forming a first joint bore and a first keyway for receiving and jointing the first joint tube and the first key and a bottom end forming a second joint tube and a second key, and a conic cap, which forms a second joint bore and a second keyway for receiving and jointing the second joint tube and the second key. The conic cap has a bottom end forming a round tube and two opposite projections to mate inward-projecting flanges and notches forming in an oil feeding port of the oil.

### BACKGROUND OF THE INVENTION

1. Field of the Invention

The present invention relates to the field of funnel for use in an oil case, and in particular to an oil case funnel that is of a structure allowing of altitude adjustability according to the location of the oil case and secure retention on an oil feeding port of the oil case.

2. The Related Arts

An automobile comprises a train of meshed gears among which friction is induced in the transmission of power. If not being properly taken care of, the gears are susceptible to generation high temperature, which reduces the life span of the gear train and increases risk of failure or malfunctioning of the automobile. Thus, it is often to supply a suitable amount of oil to the site of the gear train for lubrication and reduction of friction among the gears. The oil that is used in this way will gradually loss viscosity and thus the lubricity thereof during the use thereof. The oil must be replaced periodically. Replacing oil is often done with the use of a funnel.

Referring to FIG. 1, a known funnel 70 generally comprises a generally conic mouth portion 71, which has a lower end from which a tubular stem 72 extends. The stem 72 is insertable into an oil feeding port 50 (see FIG. 5) of an oil case, whereby oil contained in an oil bottle 60 (see FIG. 6) may be poured into the mouth portion 71 to be guided thereby to flow through the tubular stem 72 into the oil feeding port 50 of the oil case thereby realizing re-filling and replacement of oil.

However, the stem 72 of the known funnel 70 is often of a fixed and reduced diameter. Consequently, when such a diameter-reduced stem 72 is inserted into an oil feeding port 50 of an oil case that has a large bore diameter, the stem cannot be properly supported in an erected condition and thus shows an instable condition, easily leading to tipping and unsecured retention in position. This is a major drawback of the conventional funnel in this application.

Further, the conventional funnel 70 is of a fixed height, which is not adjustable to accord to the location of the oil feeding port 50 of oil case, making it inconvenient in use.

Further, the conic mouth portion of the known funnel is of a substantially flat top. This is adverse for positioning an oil bottle thereon in an up-side-down fashion, making the oil bottle instable in feeding oil into the oil case and the oil bottle must be held by a hand. This is inconvenient in use.

### SUMMARY OF THE INVENTION

A primary objective of the present invention is to provide a funnel structure for use in an oil case, wherein the funnel structure allows of adjustability through selective use of an extender and/or a coupler to accord to the locations of various oil cases and mating with an oil feeding port of oil cases of different specifications by selective and alternative use of a conic cap, so as to ensure convenience and ease of oil replacing and tightness.

Another objective of the present invention is to provide a funnel structure for use in an oil case, which comprises a funnel body having a top surface that is made inclining at a predetermined slope and having a circumferential wall forming opposite cut-offs for helping stabilizing an oil bottle in an up-side-down fashion for pouring oil.

A further objective of the present invention is to provide a funnel structure for use in an oil case, which comprises a conic cap that has a bottom end forming a round tube having an outer circumferential surface forming opposite projections, which mates inward-projecting flanges and notches forming inside an oil feeding port of an oil case for secure retention of the funnel in the oil feeding port.

### BRIEF DESCRIPTION OF THE DRAWINGS

The present invention will be apparent to those skilled in the art by reading the following description of preferred embodiments thereof, with reference to the attached drawings, wherein:

FIG. 1 is perspective view showing a conventional funnel;

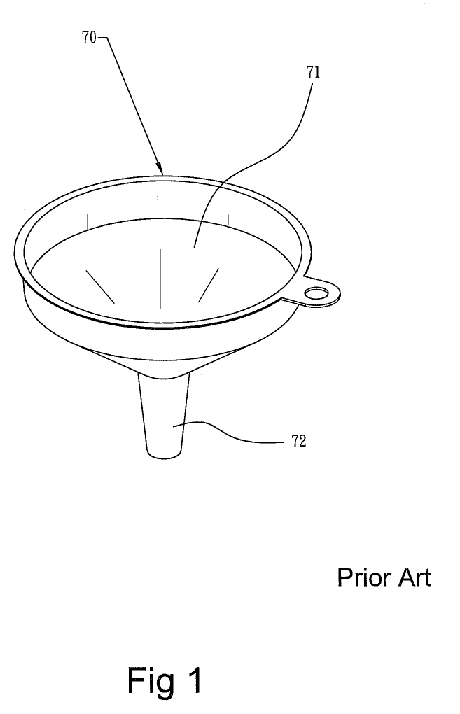

FIG. 2 is an exploded view of a funnel structure according to an embodiment of the present invention;

FIG. 3 is a cross-sectional view of the funnel structure of the present invention;

FIG. 4 is a perspective view of the funnel structure of the present invention;

FIG. 5 is a perspective view illustrating use of the funnel structure of the present invention in an oil case;

FIG. 6 is a perspective view illustrating oil being poured from an oil bottle in an up-side-down condition by using the funnel structure of the present invention;

FIG. 7 is an exploded view of a funnel structure according to another embodiment of the present invention; and

FIG. 8 is a perspective view of the funnel structure of the present invention.

### DETAILED DESCRIPTION OF THE PREFERRED EMBODIMENTS

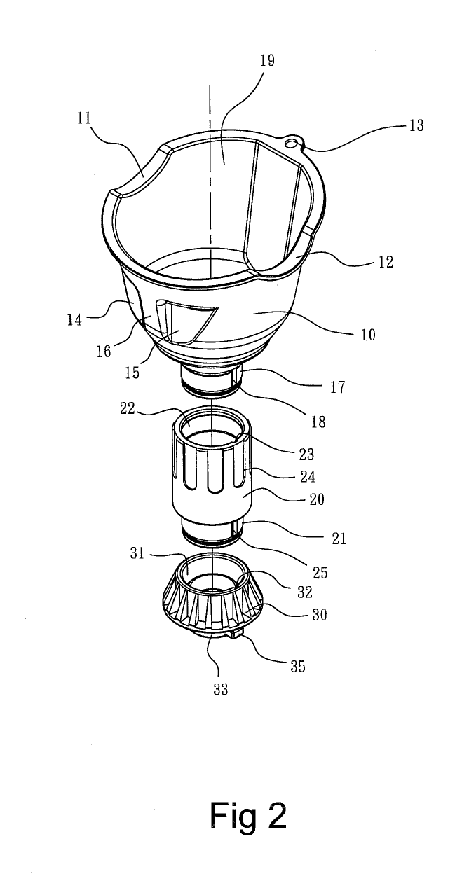

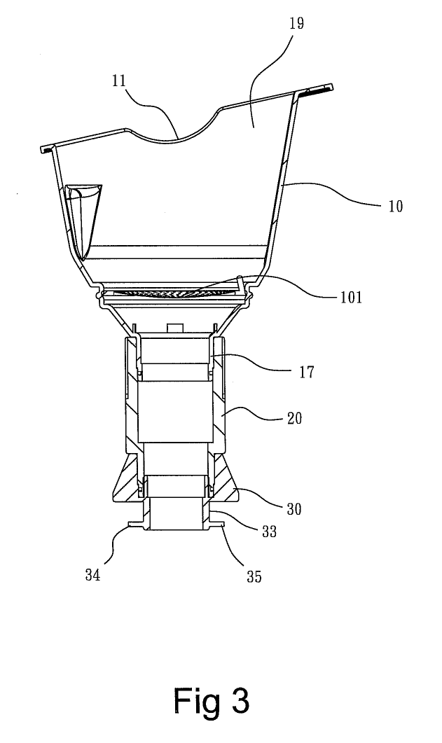

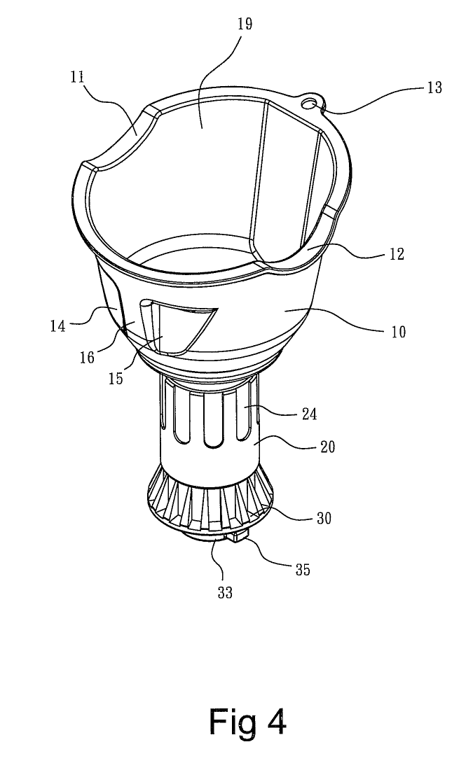

With reference to the drawings and in particular to FIGS. 2-4, which are respectively an exploded view, a cross-sectional view, and a perspective view of a funnel structure according to an embodiment of the present invention for use in an oil case. The funnel structure of the present invention comprises generally a funnel body 10, an extender 20, and a conic cap 30, which will be described in the following.

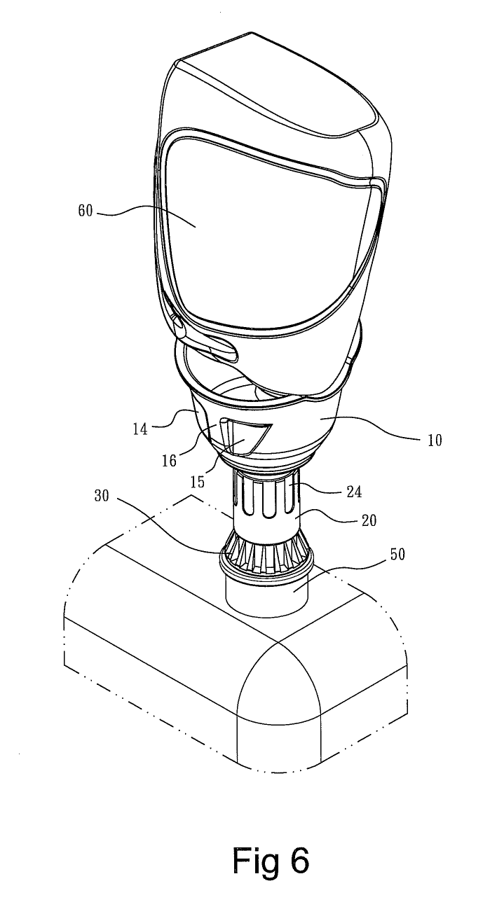

The funnel body 10 is a hollow member receiving and retaining therein a filter mesh 101 for filtering off foreign objects entraining oil poured therein. The funnel body 10 has a top end surface, which is made inclining at a predetermined slope. The top surface has a circumferential wall that is recessed at opposite portions to form two opposite cut-offs 11, 12. The two cut-offs 11, 12 help ensuring stability of locating the oil bottle 60 (see FIG. 6) in an up-side-down condition for pouring oil. The funnel body 10 also forms a hanger hole 13. The funnel body 10 has a circumferential surface that forms two spaced recesses 14, 15 for the purposes of mechanical reinforcement. The two spaced recesses 14, 15 form therebetween a raised portion 16 that helps finger gripping. The funnel body 10 has a bottom end forming a first joint tube 17 projecting downward therefrom. The first joint tube 17 has a circumferential surface forming a first raised and axially-extending key 18.

The extender 20 is of a hollow tubular configuration and has a bottom end forming a second joint tube 21 projecting downward therefrom. The second joint tube 21 has a circumferential surface forming a second raised and axially-extending key 25. The extender 20 has a top end forming a first joint bore 22 therein. The first joint bore 22 has an inner circumferential surface that is recessed in a portion thereof to form a first axially-extending keyway 23. The extender 20 has a circumferential surface in which anti-skidding patterns 24 are formed. The first joint bore 22 of the extender 20 receives and thus joints the first joint tube 17 on the bottom of the funnel body 10 and the first key 18 is fit into the first keyway 23 to prevent relative rotation therebetween.

The conic cap 30 is of a hollow configuration and has a top end forming a second joint bore 31. The second joint bore 31 has an inner circumferential surface forming a second axially-extending keyway 32. The second joint bore 31 receives and thus joints the second joint tube 21 of the extender 20 and the second key 25 is fit into the second keyway 32 to prevent relative rotation therebetween. The conic cap 30 has a bottom end forming a round tube 33 projecting downward therefrom. The round tube 33 has an outer circumferential surface forming two opposite projections 34, 35.

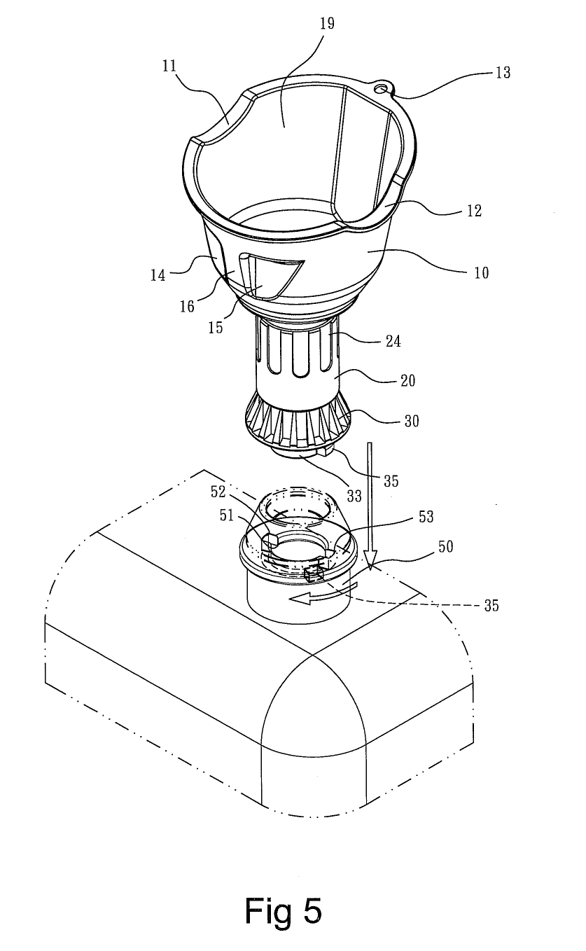

As shown in FIG. 5, the oil feeding port 50 of the oil case forms inward-projecting flanges 51 corresponding to the two projections 34, 35 of the conic cap 30 and two notches 52, 53 between the flanges for passage of the two projections 34, 35 therethrough. The two projections 34, 35 are first moved through the two notches 52, 53 of the oil feeding port 50 and then the conic cap 30 is rotated to have the two projections 34, 35 moved below and engaging the inward-projecting flanges 51 to thereby fix the conic cap 30 and the whole funnel structure to the oil case.

Referring to FIG. 6, an oil bottle 60 is positionable in an up-side-down fashion in a receptacle 19 defined in the funnel body 10 with an upper portion of the oil bottle 60 received in and held by the two cut-offs 11, 12 of the funnel body 10 to stabilize the oil bottle 60 in pouring oil. The oil poured out of the oil case is guided to flow through the funnel body 10, the extender 20, and the conic cap 30 to enter the oil case.

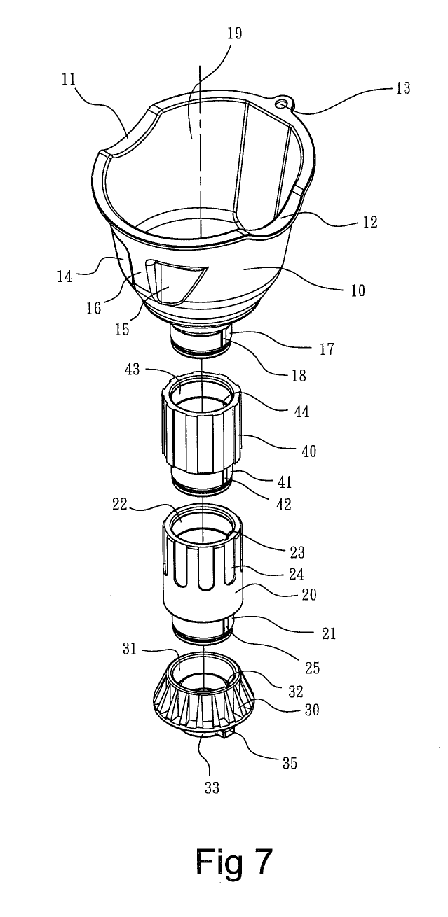

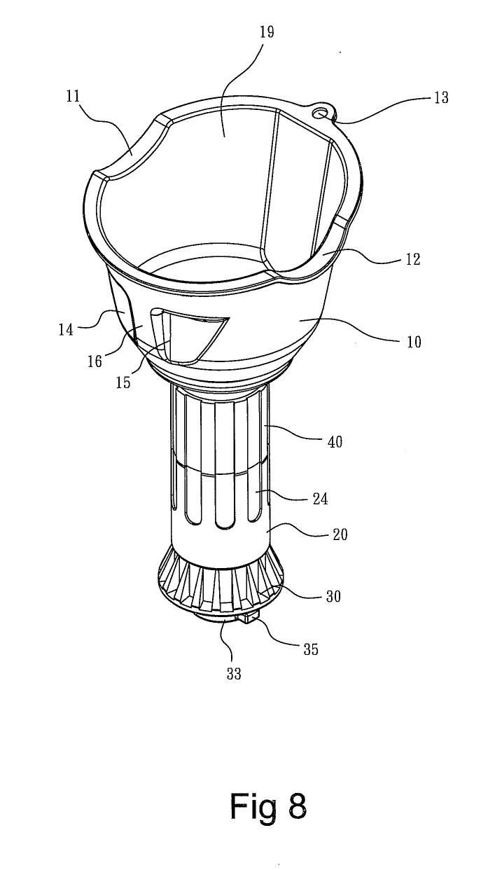

Referring to FIGS. 7 and 8, a funnel structure is provided according to another embodiment of the present invention for use in an oil case. The funnel structure comprises a funnel body 10, an extender 20, a conic cap 30, and a coupler 40, which will be described as follows.

The funnel body 10 is a hollow member and has a top end surface, which is made inclining at a predetermined slope. The top surface has a circumferential wall that is recessed at opposite portions to form two opposite cut-offs 11, 12. The two cut-offs 11, 12 help ensuring stability of locating the oil bottle 60 (see FIG. 6) in an up-side-down condition for pouring oil. The funnel body 10 also forms a hanger hole 13. The funnel body 10 has a circumferential surface that forms two spaced recesses 14, 15 for the purposes of mechanical reinforcement. The two spaced recesses 14, 15 form therebetween a raised portion 16 that helps finger gripping. The funnel body 10 has a bottom end forming a first joint tube 17 projecting downward therefrom. The first joint tube 17 has a circumferential surface forming a first raised and axially-extending key 18.

The coupler 40 is of a hollow tubular configuration and has a bottom end forming a third joint tube 41 projecting downward therefrom. The third joint tube 41 has a circumferential surface forming a third raised and axially-extending key 42. The coupler 40 has a top end forming a third joint bore 43. The third joint bore 43 has an inner circumferential surface that is recessed in a portion to form a third axially-extending keyway 44. The third joint bore 43 and the third keyway 44 of the coupler 40 receive and joint the first joint tube 17 and the first key 18 of the funnel body 10.

The extender 20 is of a hollow tubular configuration and has a bottom end forming a second joint tube 21 projecting downward therefrom. The second joint tube 21 has a circumferential surface forming a second raised and axially-extending key 25. The extender 20 has a top end forming a first joint bore 22 therein. The first joint bore 22 has an inner circumferential surface that is recessed in a portion thereof to form a first axially-extending keyway 23. The extender 20 has a circumferential surface in which anti-skidding patterns 24 are formed. The first joint bore 22 of the extender 20 receives and thus joints the third joint tube 41 of the coupler 40 and the third key 42 is fit into the first keyway 23 to prevent relative rotation therebetween. The couple 40 may have a length that is different from a length of the extender 20 and the coupler 40 and the extender 20 may be interchangeable with each other or may be alternatively used. Alternatively, the coupler 40 is connected between the funnel body 10 and the extender 20 to increase an overall length for length-extending purposes.

The conic cap is 30 of a hollow configuration and has a top end forming a second joint bore 31. The second joint bore 31 has an inner circumferential surface forming a second axially-extending keyway 32. The second joint bore 31 receives and thus joints the second joint tube 21 of the extender 20 and the second key 25 is fit into the second keyway 32 to prevent relative rotation therebetween. The conic cap 30 has a bottom end forming a round tube 33 projecting downward therefrom. The round tube 33 has an outer circumferential surface forming two opposite projections 34, 35.

In summary, the present invention provides a funnel structure for use in an oil case. The funnel structure of is capable of altitude adjustability through an extender and/or a coupler according to the vertical location where the oil case is mounted and comprises a conic cap that is selectively and/or alternatively used and/or replaced with one of different size to fit to various specifications of the oil feeding ports of different oil cases and improve convenience and ease of oil replacing and tightness. The funnel body has a top surface that is made inclining at a predetermined slope and also forms opposite cut-offs. The two cut-offs of the funnel body help stabilizing an oil bottle in position in an up-side-down condition in pouring oil. The conic cap forms in a bottom end thereof a round tube projecting therefrom and the round tube has an outer circumference forming opposite projections. This arrangement is provided for mating inward-projecting flanges and notches formed inside an oil feeding port of an oil case to ensure secure retention of the funnel in the oil feeding port of the oil case.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A funnel, comprising:
a funnel body, which has a top surface that is made inclining at a predetermined slope and has a circumferential wall forming two opposite cut-offs for helping stabilizing an oil bottle in an up-side-down condition for pouring oil, the funnel body having a bottom forming a first joint tube projecting therefrom, the first joint tube has a circumferential surface forming a first key;
an extender, which is of a hollow tubular configuration and has a bottom end forming a second joint tube projecting therefrom, the second joint tube having a circumferential surface forming a second key, the extender having a top end forming a first joint bore, the first joint bore having an inner circumferential surface forming a first keyway, the first joint bore of the extender selectively receiving the first joint tube of the funnel body therein with the first key fit into the first keyway for rotatably fixing; and
a conic cap, which is of a hollow configuration and has a top end forming a second joint bore, the second joint bore having an inner circumferential surface forming a second keyway, the second joint bore selectively receiving the second joint tube of the extender with the second key fit into the second keyway for rotatably fixing, the conic cap having a bottom end forming a round tube projecting therefrom, the round tube having an outer circumferential surface forming opposite projections, whereby the projections are adapted to move through notches formed between inward-projecting flanges formed inside an oil feeding port of an oil case and the conic cap is rotated to have the projecting located below and engaging the inward-projecting flanges of the oil feeding port for secure retention of the conic cap in the oil feeding port.

2. The funnel as claimed in claim 1, wherein the funnel body comprises a filter mesh received therein for filtering off foreign objects.

3. The funnel as claimed in claim 1, wherein the funnel body forms a hanger hole for hanging and storing the funnel body.

4. The funnel as claimed in claim 1, wherein the funnel body has a circumferential surface forming two recesses for reinforcement and a raised portion between the recesses for finger gripping.

5. The funnel as claimed in claim 1, wherein the extender has a circumferential surface forming anti-skidding patterns.

6. The funnel as claimed in claim 1 further comprising a coupler, which is of a hollow tubular configuration and has a bottom end forming a third joint tube projecting therefrom, the third joint tube having a circumferential surface forming a third key, the coupler having a top end forming a third joint bore, the third joint bore having an inner circumferential surface forming a third keyway, the coupler and the extender being selectively or alternatively used or the coupler being selectively connectable between the funnel body and the extender to increase an overall length of the funnel.
